(19) United States
(12) Patent Application Publication
(10) Pub. No.: US 2009/0234572 A1
(43) Pub. Date: Sep. 17, 2009

(54) Surrounding Search Data Generating System, Surrounding Search System, Surrounding Search Data Generating Method, Surrounding Search Method, and Navigation Apparatus

(75) Inventors: Akiko Matsuo, Aichi (JP); Kazumichi Hirai, Aichi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD, ANJO-SHI, AICHI (JP)

(21) Appl. No.: 11/992,098

(22) PCT Filed: Sep. 27, 2006
(86) PCT No.: PCT/JP2006/319191

§ 371 Date: Mar. 14, 2008

(30) Foreign Application Priority Data
Sep. 28, 2005 (JP) 2005-282482

(51) Int. Cl. G01C 21/36

(52) U.S. Cl. 701/201; 701/207

(57) ABSTRACT

The disclosed system makes it possible to conduct a search for the most appropriate facility, while a vehicle is driven on a limited access road. The system judges whether a facility is located within a surrounding search area and generates first data when the facility is judged to be within the surrounding search area. The system also sets a target point at a predetermined location and judges whether there is any facility that satisfies a predetermined data generation condition. Second data is generated in correspondence with the target point when a judgment is made that one or more facilities satisfy the data generation condition. The first data and the second data are recorded onto a recording medium.

### TECHNICAL FIELD

The present invention relates to a surrounding search data generating system, a surrounding search system, a surrounding search data generating method, a surrounding search method, and a navigation apparatus.

### BACKGROUND ART

In conventional navigation apparatuses, a current location of a vehicle is detected with the use of, for example, a GPS (Global Positioning System) sensor, map data is read from a data recording unit, and a map screen is formed on a displaying unit, so that a vehicle position indicating the current location, a map of the surroundings of the vehicle location and the like are displayed on the map screen. Thus, the operator of such a navigation apparatus (i.e., the driver of the vehicle) is able to drive the vehicle in accordance with the vehicle location, the map of the surroundings of the vehicle location, and the like that are displayed on the map screen.

When the driver of the vehicle inputs a destination and specifies a search criterion, a route search process is performed based on the search criterion. Accordingly, a search is conducted for a route to drive from a starting point indicated as the current location to the destination, based on the map data. The route that has been found in the search, i.e., the “searched route”, is displayed on the map screen together with the vehicle location, so that guidance for the searched route, i.e., “route guidance”, is provided. Thus, the driver is able to drive the vehicle along the searched route that is displayed.

While the driver is driving a vehicle on a road, if he/she wishes to search for facilities (i.e., objects) that are located in the surroundings (vicinity) of the current location, the navigation apparatus conducts a search for facilities that are positioned within a predetermined area (e.g., an area having a radius of 30 kilometers) in which the current location is located at the center. Of the facilities that have been found in the search, the navigation apparatus displays, in a list as a search result, only the facilities that are located within a band-shaped area having a predetermined width and that is centered on the road (e.g., 100 meters to the left and to the right of the road) on which the vehicle is driven. In a case where the road on which the vehicle is driven is a limited access-road, such as an expressway or a toll road, for example, when the driver specifies an exit of the limited access road, the navigation apparatus conducts a search for facilities that are located in the vicinity of the specified exit. See, for example, Japanese Patent Application Publication No. 2004-170233

### DISCLOSURE OF THE INVENTION

### Problems to be Solved by the Invention

However, the conventional navigation apparatus conducts a search for only the facilities that are located in the vicinity of the specified exit. Thus, in a case where the driver of the vehicle wishes to find the most appropriate facility, for example, a facility that he/she is able to reach in a short period of time, the driver needs to specify a plurality of exits, one by one. In this situation, not only do the operations required of the driver become bothersome, but also the level of efficiency of the search is low.

It is an object of the present invention to solve the problems of the conventional navigation apparatuses and to provide a surrounding (vicinity) search data generating system, a surrounding (vicinity) search system, a surrounding (vicinity) search data generating method, a surrounding (vicinity) search method, and a navigation apparatus that make it possible to conduct a search for the most appropriate one facility while a vehicle is driven on a limited access road, e.g. expressway, to simplify the operations required of the driver, and to enhance the level of efficiency of the search.

### Means for Solving the Problems

In order to achieve the object, a surrounding (vicinity) search data generating system according to the present invention includes: a facility judgment processing means for judging whether a predetermined facility is located within a surrounding (vicinity) search area that is specified (predefined) along a road having an entrance and an exit; a first data generation processing means for generating, in a case where the predetermined facility is located within the surrounding search area, data for the predetermined facility as first data; a target point setting processing means for setting, at a predetermined location, a target point to be used as a target for generating second data; a condition satisfaction judgment processing means for judging whether there is any facility that satisfies a predetermined data generation condition; a second data generation processing means for generating, in a case where there are one or more facilities that satisfy the predetermined data generation condition, data for the one or more facilities that satisfy the predetermined data generation condition as second data, in correspondence with the target point; and a data record processing means for recording the first data and the second data onto a recording medium.

### EFFECTS OF THE INVENTION

According to the present invention, not only for the facilities that are positioned within the surrounding search area, but also for the facilities that satisfy the data generation condition, the second data is generated, so that the facilities are used as the targets of the surrounding (vicinity) search. Thus, it is possible to easily conduct a search for the facility most appropriate for the driver. Consequently, it is possible to not only simplify the operations of the operating unit required of the driver, but also enhance the level of efficiency of the search.

### BRIEF DESCRIPTION OF THE DRAWINGS

FIG. 1 is a block diagram of a navigation system according to a first embodiment of the present invention.

FIG. 2 illustrates a surrounding (vicinity) search according to the first embodiment of the present invention.

FIG. 3 is a block diagram of a data generating apparatus according to the first embodiment of the present invention.

FIG. 4 is a flowchart of a method for generating dummy data included in surrounding (vicinity) search data according to the first embodiment of the present invention.

FIG. 5A is a functional block diagram of a surrounding search data generating system according to the first embodiment of the present invention; and FIG. 5B is a functional block diagram of a navigation apparatus according to the first embodiment of the present invention.

FIG. 6 is a flowchart of a routine executed by a surrounding (“vicinity”) search processing means according to the first embodiment of the present invention.

FIG. 7 shows an example of a category selecting screen according to the first embodiment of the present invention.

FIG. 8 shows an example of a search result display screen according to the first embodiment of the present invention.

FIG. 9 shows is a drawing that shows an example of a search result display screen according to a second embodiment of the present invention.

### BRIEF EXPLANATION OF THE REFERENCE NUMERALS

14: NAVIGATION APPARATUS
35: DISPLAYING UNIT
51: INFORMATION CENTER
63: NETWORK
AR1: SURROUNDING SEARCH AREA
e1, e2: EXIT
Hw1, Hw2: AUTOMOBILE-ONLY ROAD
Jc: JUNCTION
Pr: CURRENT POSITION
p1-p4: TARGET POINT
r1-r3: GENERAL ROAD
Sa1-Sa3: SERVICE AREA

### PREFERRED EMBODIMENTS OF THE INVENTION

Embodiments of the present invention will be explained in detail, with reference to the accompanying drawings.

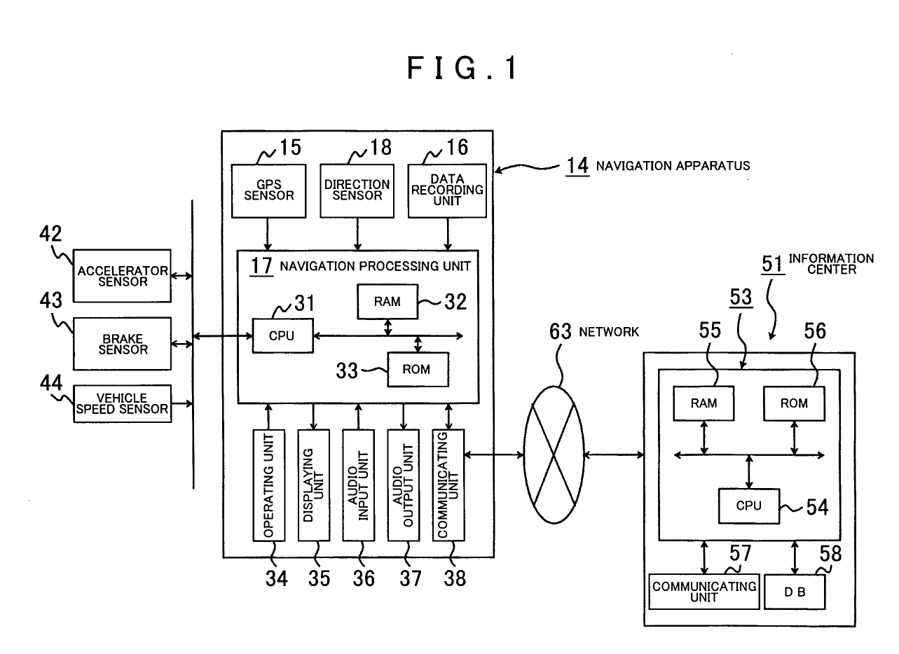

FIG. 1 is a diagram that shows a navigation system according to a first embodiment of the present invention.

In the drawing, 14 denotes an information terminal such as, for example, an in-vehicle navigation apparatus that is installed in a vehicle. 63 denotes a network. 51 denotes an information center that serves as an information provider. An embodiment of a navigation system according to the present invention includes the navigation apparatus 14, the network 63, and the information center 51.

The navigation apparatus 14 includes: a GPS sensor 15 that detects a current location of the vehicle by receiving a satellite signal generated by an artificial satellite; a data recording unit 16 that serves as an information recording unit and also as a storage device and that has recorded therein map data, i.e. information related to maps, as well as other various types of information such as information related to facilities; a navigation processing unit 17 that performs various types of computational processes such as a navigation process, based on various types of information; a direction sensor 18 that detects a direction in which the vehicle is oriented, i.e., heading of the vehicle; an operating unit 34 that serves as a first input unit and is used by a driver of the vehicle who is an operator of the navigation apparatus 14 for input; a displaying unit (display unit) 35 that serves as a first output unit and displays various types of images on a screen (not shown in the drawing) so as to inform the driver; an audio input unit 36 that serves as a second input unit and is used for audio input; an audio output unit 37 that serves as a second output unit that provides various types of audio information to the driver, and a communicating unit 38 that serves as a transmitting and receiving unit and functions as a communication terminal. The GPS sensor 15, the data recording unit 16, the direction sensor 18, the operating unit 34, the displaying unit 35, the audio input unit 36, the audio output unit 37, and the communicating unit 38 are connected to the navigation processing unit 17.

The GPS sensor 15 is configured so as to be able to detect the current location and also to detect a current time, the speed of the vehicle, and the like.

As shown in FIG. 1, according to the present embodiment, the GPS sensor 15 and the direction sensor 18 are separate elements. However, it is acceptable to have another arrangement in which a current location is detected based on a combination of position coordinates, a direction, and a traveling direction with the use of the GPS sensor 15 and the direction sensor 18 that together serve as a current position (current location) detecting unit. Alternatively, because the GPS sensor 15 is able to calculate the speed and the traveling direction of the vehicle based on the received satellite signals, it is acceptable to determine the current location using only the GPS sensor 15.

Also, although the GPS sensor 15 is used in the present embodiment, it is acceptable to use, instead of the GPS sensor 15, a distance sensor, a steering sensor, an altimeter, and the like, individually or in combination. Also, although the direction sensor 18 is used to detect the direction of the vehicle in the present embodiment, it is acceptable to use, instead of the direction sensor 18, a gyro sensor, a geomagnetic sensor, or the like, in combination.

Further, connected to the navigation processing unit 17 are an accelerator sensor 42 that serves as an engine load detecting unit and that detects operation of the accelerator pedal (not shown in the drawing), based on degree of accelerator opening; a brake sensor 43 that serves as a braking detecting unit and detects operation of the brake pedal (not shown in the drawing), based on the amount by which the brake pedal is depressed; and a vehicle speed sensor 44 that serves as a vehicle speed detecting unit and detects vehicle speed S. An operation information detecting unit that detects the information related to the operations performed by the driver on the vehicle is constituted by elements including the accelerator sensor 42 and the brake sensor 43. The GPS sensor 15 is able to detect the vehicle speed, in addition to the current location and the direction of the vehicle.

The data recording unit 16 has a map database that includes map data files. The map database stores therein map data. The map data includes intersection data related to intersections, node data related to nodes, road data related to roads and road links, search data that has been processed for the use in searches, facility data related to facilities, and surrounding search data (vicinity search data) that has been generated in order to conduct a search for facilities that are located in the vicinity of a route that has been specified in advance (predefined) or the current location of the vehicle, in other words, data in order to conduct a surrounding area search, as well as feature data related to features. The data recording unit 16 also has recorded therein data used for outputting predetermined information via the audio output unit 37.

In addition, the data recording unit 16 has a statistic database that includes statistic data files and a driving history database that includes driving history data files. The statistic data files and the driving history data files respectively contain statistical data and driving history data, as actual record data.

The statistical data is history information that consists of the actual records, i.e., a history of traffic information that was provided in the past. The statistical data is generated from various types of information individually or in combination and, as necessary, applying a processing step and/or a statistical process thereto. Examples of the various types of information include: traffic information that was provided in the past by a road traffic information center (not shown in the drawing) such as a VICS (a registered trademark: Vehicle Information and Communication System) center or a RDS-TMC (Radio Data System-Traffic Message Channel: traffic information service using an FM multiplex broadcast) that serves as an information provider; road traffic census information that is data indicating amounts of traffic based on a road traffic census provided by the Japanese Ministry of Land, Infrastructure, and Transport; and road time table information provided by the Japanese Ministry of Land, Infrastructure, and Transport.

The data items in the statistical data include: link numbers corresponding to the road links; direction flags indicating directions in which vehicles are driven; information types indicating the types of information; the levels of traffic congestion corresponding to predetermined time periods; link required travel time indicating the time required to drive the road links during the predetermined time periods; and average data for the link required travel time corresponding to different days of the week (for example, data for weekday average).

The driving history data indicates actual driving records, i.e., the actual records of the driving of vehicles on the various roads as collected by the information center 51 from a plurality of vehicles such as the vehicle on which the navigation apparatus is installed and/or other vehicles. The driving history data is calculated and accumulated as probe data, based on the driving data.

The data items in the driving history data include: travel time that is required in order to drive the road links during predetermined time periods; and levels of traffic congestion experienced while driving the road links during the predetermined time periods. The statistical data may include the driving history data. Also, in the present embodiment, the levels of traffic congestion are used as a traffic congestion index indicating the degree of traffic congestion. The levels of traffic congestion include “congested”, “crowded”, and “not congested”.

The data recording unit 16 includes a disk (not shown in the drawing) such as a hard drive, a CD, a DVD, an optical disk, or the like, for the purpose of recording various types of data. The data recording unit 16 also includes a head, which is not shown in the drawing, such as a read/write head that is used for reading or writing various types of data. It is also possible to use a memory card or the like, as the data recording unit 16.

In the present embodiment, the data recording unit 16 includes the map database, the statistic database, the driving history database, and the like. However, it is also acceptable to include the map database, the statistic database, the driving history database, and the like in the information center 51.

The navigation processing unit 17 includes: a CPU 31 that serves as a controlling device that performs the overall control of the navigation apparatus 14 and also serves as a computing device; a RAM 32 that is used as a working memory while the CPU 31 executes various types of computational processes; a ROM 33 that has recorded therein a program used for the over control by CPU 31, as well as other various types of programs for conducting a search for a route to a destination and for providing route guidance; and a flash memory (not shown in the drawing) that is used for recording therein various types of data and programs.

In the present embodiment, various types of programs are recorded in the ROM 33 and various types of data are recorded in the data recording unit 16. However, alternatively, both the programs and the data may be recorded on a disk or the like. In this case, it is possible to read the programs, the data, and the like from the disk and to write the read programs and the read data into a flash memory. Thus, it is possible to update the programs, the data, and the like by replacing the disk. Further, it is possible to receive the programs, the data, and the like via the communicating unit 38 and to write the received programs and the received data into the flash memory included in the navigation processing unit 17.

The operating unit 34 is operated by the driver and is used for correcting a current location that is indicated when starting the vehicle, inputting a starting point and/or a destination, inputting a location point to be driven through, and/or turning on the communicating unit 38. As the operating unit 34, it is acceptable to use a keyboard, a mouse, and the like that are provided independently of the displaying unit 35. Alternatively, as the operating unit 34, it is acceptable to use a touch panel that allows a user to perform predetermined input operations by touching or clicking operations performed on various types of keys, switches, and buttons that are displayed as images on a screen formed on the displaying unit 35.

A display device may be used as the displaying unit 35. On the various types of screens formed on the displaying unit 35, it is possible to display the current location of the vehicle and to display a direction of the vehicle, to display maps, a searched route, i.e. a route determined by search, guidance information along the searched route, and traffic information, to display the distance to the next intersection on the searched route, and to display the direction to be taken at the next intersection. In addition, it is possible to display operation guidance, operation menus, and guidance related to the keys for the image operating unit, the operating unit 34, the audio input unit 36, and the like, as well as broadcast programs provided by FM multiplex broadcast.

The audio input unit 36 is a microphone or the like (not shown in the drawings), enabling input of necessary information by voice. The audio output unit 37 includes a voice synthesizer and a speaker, which are not shown in the drawing. From the audio output unit 37, the searched route, the guidance information, the traffic information, and the like are output by using, for example, voice synthesized by the voice synthesizer.

The communicating unit 38 includes: a beacon receiver that receives, as a radio or optical beacon signal, various types of information including current traffic information transmitted from the road traffic information center and other general information, via a radio beacon or optical beacon provided roadside; and an FM receiver that receives various types of information as an FM multiplex broadcast from a FM broadcast station. The traffic information includes traffic congestion information, traffic regulation information, parking information, traffic accident information, and information regarding degree of congestion in service areas. The general information includes news, weather forecasts, and the like. The beacon receiver and the FM receiver are integrated into a unit as a VICS receiver; however, the beacon receiver and the FM receiver may be separate units.

The traffic information includes: information types indicating the types of information; grid numbers each identifying a grid unit; link numbers each identifying a road link that connects two points (for example, two intersections) and each indicating direction of travel on the road link (currently driven direction or direction of opposing lane or lanes); and link information that shows the content of the information provided in correspondence with the link numbers. For example, when the traffic information is traffic congestion information, the link information includes: congestion beginning-point data indicating a distance from a starting point on the road link to the beginning point of traffic congestion; the level of traffic congestion; a congestion length indicating the length of the congested section from the beginning point of the traffic congestion to the end of the traffic congestion, and link required travel time indicating the length of time required to drive the road link.

The communicating unit 38 functions to receive, from the information center 51, various types of data such as the map data, the statistical data, and the driving history data, as well as various types of information such as the traffic information and the general information, via the network 63.

In order to realize such functions, the information center 51 includes: a server 53; a communicating unit 57 that is connected to the server 53; and a database (DB) 58 that serves as an information recording unit. The server 53 includes a CPU 54 that serves as a controlling device and also serves as a computing device, a RAM 55, and a ROM 56. The database 58 has recorded therein various types of data that are the same as the data recorded in the data recording unit 16, such as the map data, the statistical data, and the driving history data. Further, the information center 51 functions to provide, in a real-time manner, various types of information including the current traffic information that has been transmitted from the road traffic information center and general information, as well as driving history data that has been collected from a plurality of vehicles (such as the vehicle on which the navigation apparatus is installed and/or other vehicles).

The navigation system, the navigation processing unit 17, the CPU 31, the CPU 54, and the server 53 function as a computer, individually or in combination of two or more, so as to perform computational processes based on the various types of programs and the various types of data. A recording medium in the form of a disk, a memory card, or the like that is inserted into the data recording unit 16. Additional recording mediums include the RAM 32, the RAM 55, the ROM 33, the ROM 56, the database 58, the flash memory, and the like. The computing device, may be a MPU or the like, instead of the CPU 31 or the CPU 54.

Next, the basic operation of the navigation system described above will be explained.

First, when the driver operates the operating unit 34 to activate the navigation apparatus 14, a navigation initialization processing means (i.e., a navigation initialization processing unit), that is included in the CPU 31, executes a navigation initialization process, to read the current location of the vehicle that has been detected by the GPS sensor 15 and the direction of the vehicle that has been detected by the direction sensor 18 and also initializes the various types of data. Next, a matching processing means (i.e., a matching processing unit), that is included in the CPU 31, executes a matching process so as to identify the current position by determining the road link on which the current position is located, based on a locus of the current position that has been read and on the shapes and the positional arrangements of the road links that constitute the roads surrounding the current location.

After that, an information obtainment processing means (i.e., an information obtainment processing unit), that is included in the CPU 31, performs an information obtainment process, so as to obtain the map data by either reading it from the data recording unit 16 or by receiving it from the information center 51 or the like, via the communicating unit 38. In a case where the information obtainment processing means obtains the map data from the information center 51 or the like, the information obtainment processing means downloads the received map data into a flash memory.

Subsequently, a display processing means (i.e., a display processing unit), that is included in the CPU 31, displays one of the various types of screens on the displaying unit 35. For example, a map display processing means (i.e., a map display processing unit), included in the display processing means, executes a map display routine so as to form a map screen on the displaying unit 35, to display a map of the vicinity on the map screen, to display the current position as the vehicle location and to display vehicle direction.

Accordingly, the driver of the vehicle is able to drive the vehicle according to the map, the current location of the vehicle, and the direction of the vehicle.

When the driver operates the operating unit 34 to input a destination, a destination setting processing means (i.e., a destination setting processing unit), that is included in the CPU 31, executes a destination setting routine to set a destination. The driver is also able to input and set a starting point, as necessary. Also, the driver is able to register a predetermined location in advance and to set the registered location as a destination. The driver then operates the operating unit 34 to input a search criterion, and a search criterion setting processing means (i.e., a search criterion setting processing unit), that is included in the CPU 31, then executes a search criterion setting routine to set the search criterion.

When the destination and the search criterion have been set as explained above, a route search processing means (i.e., a route search processing unit), that is included in the CPU 31, executes a route search routine in which it reads the current location, the destination, and the search criterion and also reads the search data and the like from the data recording unit 16. The route search processing means conducts a search for a travel route from the starting point, indicated as the current location, to the destination, subject to the search criterion and based on the current location, the destination, the search data, and the like, and outputs route data indicating the route determined by search, i.e. the searched route. The route that has the smallest sum of link costs is selected as the searched route.

In a case where a road has a plurality of lanes, and the driving lane has also been detected, the route search processing means conducts the search for the travel route, i.e. “searched route”, in units of lanes. In this case, the route data includes a lane number for the driving lane.

Subsequently, a guidance processing means (i.e., a guidance processing unit), that is included in the CPU 31, executes a guidance routine to provide route guidance. To execute that routine a route display processing means (i.e., a route display processing unit), included in the guidance processing means, executes a route display routine so as to read the route data and display the searched route on the map screen, according to the route data. In the case where the search is conducted for the searched route in units of lanes, the route display processing means provides route guidance with reference to lanes at a predetermined location, such as a guidance intersection, and displays the driving lane for which the route guidance is provided in an enlarged map of the intersection. In addition, as necessary, an audio output processing means (i.e., an audio output processing unit), that is included in the guidance processing means, generates an audio (voice) output to provide route guidance for the searched route via the audio output unit 37.

Also, the information center 51 is able to perform a route search in which the CPU 31 transmits the current location, the destination, the search criterion, and the like to the information center 51. When the information center 51 has received the current location, the destination, the search criterion, and the like, a route search processing means (i.e., a route search processing unit), that is included in the CPU 54, executes a route search routine that is the same as the one performed by the CPU 31, so as to read the search data and the like from the database 58. The route search processing means conducts a search for a travel route from the starting point to the destination, under the search criterion, based on the current location, the destination, the search data, and the like and outputs route data for the searched route. Subsequently, a transmission processing means (i.e., a transmission processing unit), that is included in the CPU 54, executes a data transmission routine to transmit the route data to the navigation apparatus 14. Thus, in the navigation apparatus 14, when a basic information obtainment processing means (i.e., a basic information obtainment processing unit), that is included in the CPU 31, has received the route data from the information center 51, the guidance processing means performs the route guidance as described above.

In a case where there is a guidance intersection on the searched route, when the vehicle has reached a route guidance point that is positioned a predetermined distance (e.g., X meters) in advance of the guidance intersection, an enlarged intersection map display processing means (i.e., an enlarged intersection map display processing unit), included in the guidance processing means, executes an enlarged intersection map display process to generate an enlarged intersection map as described above in a predetermined area of the map screen and to provide route guidance using the enlarged intersection map. More specifically, the enlarged intersection map display processing means displays, in the enlarged intersection map, a map of the vicinity of the guidance intersection, the searched route, and landmarks such as facilities that can be used as landmarks at the guidance intersection. In the case where the route guidance is provided relating to lanes, the enlarged intersection map display processing means also displays the driving lane. In addition, as necessary, the audio output processing means outputs audio instruction, for example, “Turn left after X meters”, from the audio output unit 37 the route guidance.

It is also possible to use the navigation apparatus 14 or the navigation system as a surrounding search system to conduct a search for a facility (i.e., an object) that is located in the surroundings of the current location, the destination, the searched route, and the like. When the driver operates the operating unit 34 or the audio input unit 36 to request, for example, a search to be conducted for a facility that is located in the surroundings of the searched route, the surrounding search data is read from the data recording unit 16, the database 58, or the like, so that a search is conducted for a facility located in the vicinity of the searched route, and the driver is informed of the facility found in the search.

Next, a method for generating the surrounding search data will be explained.

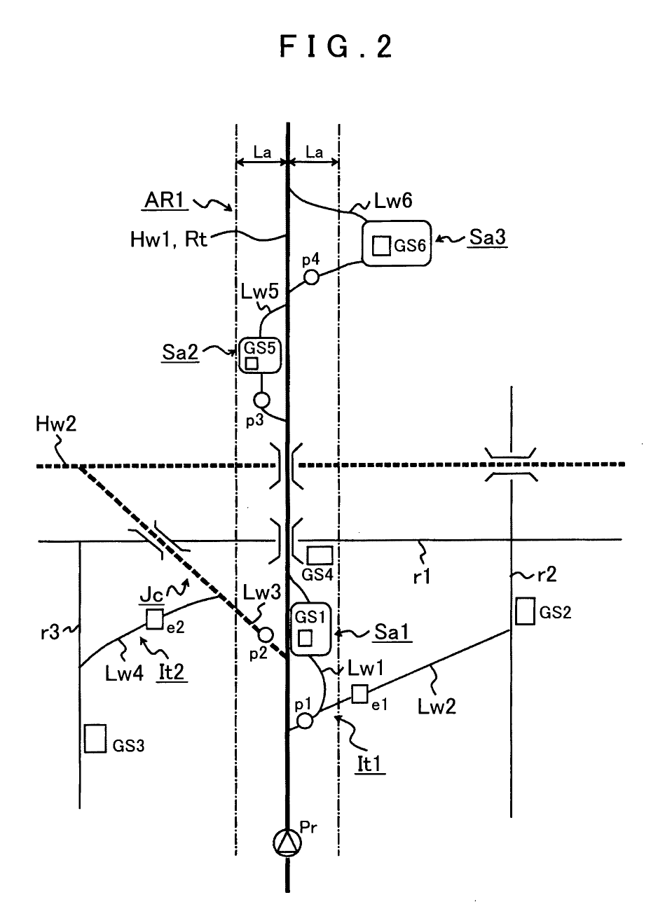

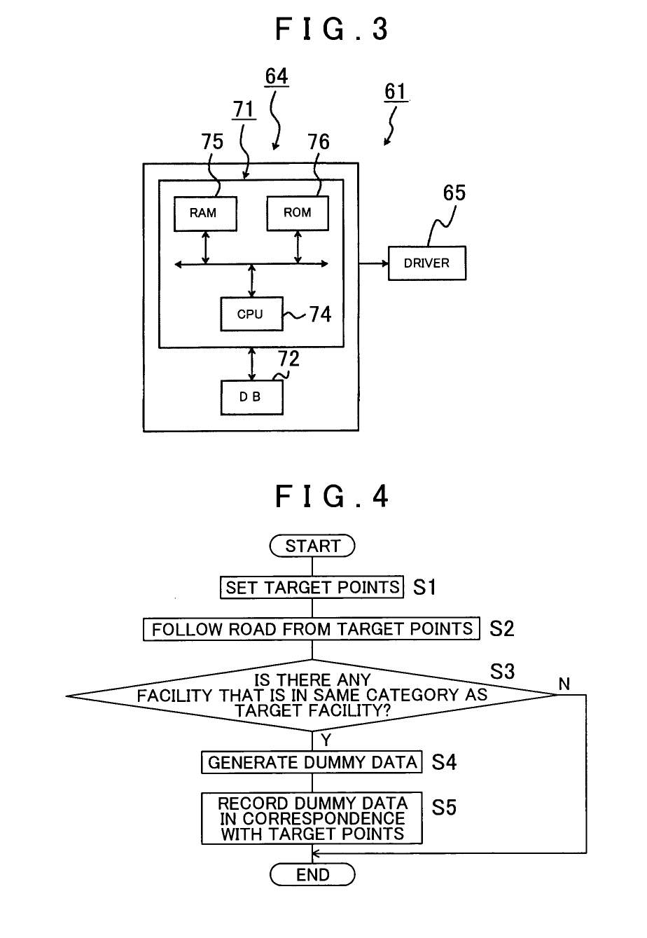

FIG. 2 illustrates a surrounding (vicinity) search according to the first embodiment of the present invention. FIG. 3 is a block diagram of a data generating apparatus according to the first embodiment of the present invention. FIG. 4 is a flowchart of method for generating dummy data included in the surrounding search data according to the first embodiment of the present invention.

In FIG. 2, Pr denotes the current location. Hwi (i=1, 2, . . . ) denotes a limited access road, e.g. an automobile-only road such as an expressway or a toll road that has one or more entrances and exits and that has limited access. rj (j=1, 2, . . . ) denotes a general road such as a national road or a prefectural road. In the present embodiment, the automobile-only road Hw1 serves as a searched route Rt.

Lwα (α=1, 2, . . . ) denotes a rampway used as an entrance or exit. ltβ (β=1, 2, . . . ) denotes an interchange. eβ (β=1, 2, . . . ) denotes an exit with a gate provided at an interchange ltβ. Saγ (γ=1, 2, . . . ) denotes a service area that is provided as a “stop-over” area. In the example of the present embodiment, service areas (Saγ) are used as “stop-over” areas; however, parking areas may also be “stop-over” areas. Each of the service areas (Saγ) has a parking space, a service facility such as a restaurant, as well as a gas station. GSδ (δ=1, 2, . . . ) denotes a gas station that is provided in a service area (Saγ), on a general road rj, or the like.

At a service area Sa1, a service lane (“rampway”) Lw1 branches off from the main lanes of the automobile-only road Hw1 and merges back into the main lanes. A gas station GS1 accessed by the service lane Lw1. A rampway Lw2 is provided at an interchange It1 so as to connect the limited access road Hw1 and a general road r2 together. An exit e1 is provided on the rampway Lw2. A gas station GS2 is provided on the general road r2, whereas a gas station GS4 is located on general road r1.

The rampway Lw3 connects the limited access road Hw1 and the limited access road Hw2 at a junction Jc. A rampway Lw4 branches off from the rampway Lw3 so as to connect the rampway Lw3 and a general road r3. An exit e2 is provided on the rampway Lw4. A gas station GS3 is located on the general road r3.

At a service area Sa2, a service lane (“rampway”) Lw5 branches off from the main lanes of the limited access road Hw1 and merges back into the main line. A gas station GS5 is provided on the service lane Lw5. At a service area Sa3, a service lane Lw6 branches off from the main lanes of the limited access road Hw1 and merges back into the main lanes. A gas station GS6 is accessed by the service lane Lw6.

Next, the method for generating the surrounding search data will be explained, with reference to FIGS. 3 and 4.

A disk (not shown in the drawing) that is to be inserted into the data recording unit 16 (FIG. 1) is produced by a disk provider who is an information generator. Thus, the disk provider generates and edits the surrounding search data and records the surrounding (vicinity) search data onto the disk, by using a data generating apparatus 61. It is also possible to generate or edit the surrounding search data and to record the surrounding search data into a flash memory or the GPS sensor 15, by using the navigation apparatus 14 or the server 53. In this situation, various types of processes executed by a surrounding search data generating unit 64, included in the data generating apparatus 61, are performed by the navigation processing unit 17 or the server 53.

The data generating apparatus 61 includes a driver 65 in addition to the surrounding search data generating unit 64. The driver 65 drives a recording head or the like, which is not shown in the drawing, in order to record the surrounding search data generated by the surrounding search data generating unit 64 onto the disk.

The surrounding search data generating unit 64 includes a server 71 and a database (DB) 72. The server 71 includes: a CPU 74 that serves as a computing device; a RAM 75 that is used as a working memory for the CPU 74 in its execution of various types of computational processes; and a ROM 76 that has recorded thereon various types of data, programs, and the like. The database 72 contains the same data as that recorded in the data recording unit 16 or the database 58. A surrounding search data generation means (i.e., a surrounding search data generation processing unit 90), that is included in the CPU 74, executes a surrounding search data generation routine so as to generate surrounding search data for certain roads such as limited access road Hw1, based on the map data that has been read from the database 72 and to record the generated surrounding search data onto the disk. The CPU 74 included in the data generating apparatus 61 functions as a computer.

When surrounding search data is generated for a limited access road Hwi, for example, for the limited access road Hw1 shown in FIG. 2, a surrounding search area AR1 is specified in advance along the limited access road Hw1, the surrounding search area AR1 having a predetermined width La (e.g., 100 meters) to the left and to the right of the limited access road Hw1. Data for the facilities that are located within the surrounding search area AR1 is recorded onto the disk as the surrounding search data, with classification by category. The surrounding search data includes the name of each of the facilities, coordinates indicating the position of each of the facilities, information about each of the facilities, a link number indicating a road link along which each of the facilities is located, and the like.

The distance La can be arbitrarily selected when the surrounding search data is generated. However, as the distance La is increased the surrounding search area AR1 becomes larger and the number of facilities to be found in the search becomes larger, and it thereby becomes more difficult for the driver to find the most appropriate one facility. On the other hand, as La is decreased, because the surrounding search area AR1 becomes smaller, the number of facilities to be found in the search becomes smaller, and it becomes more difficult to detect the most appropriate facility for the driver.

To cope with the above-described problem, in the present embodiment, the surrounding search data is generated and recorded onto the disk in such a manner that, even if La is set to be short, it is possible to conduct a search also for facilities that are located outside of the surrounding search area AR1, but satisfy a predetermined data generation condition.

In the present embodiment, the surrounding search data includes first data and second data. The first data is real data, which is data for the facilities that are actually located within the surrounding search area AR1. The second data is dummy data, which is data for facilities that is generated when the data generation condition is satisfied, no matter whether or not the facilities are actually located within the surrounding search area AR1. The dummy data is data that is expected to be useful for the driver, no matter whether the facilities are positioned within the surrounding search area AR1 or not. The dummy data is set, generated, and recorded onto the disk, by using a format as if the facilities were located within the surrounding search area AR1.

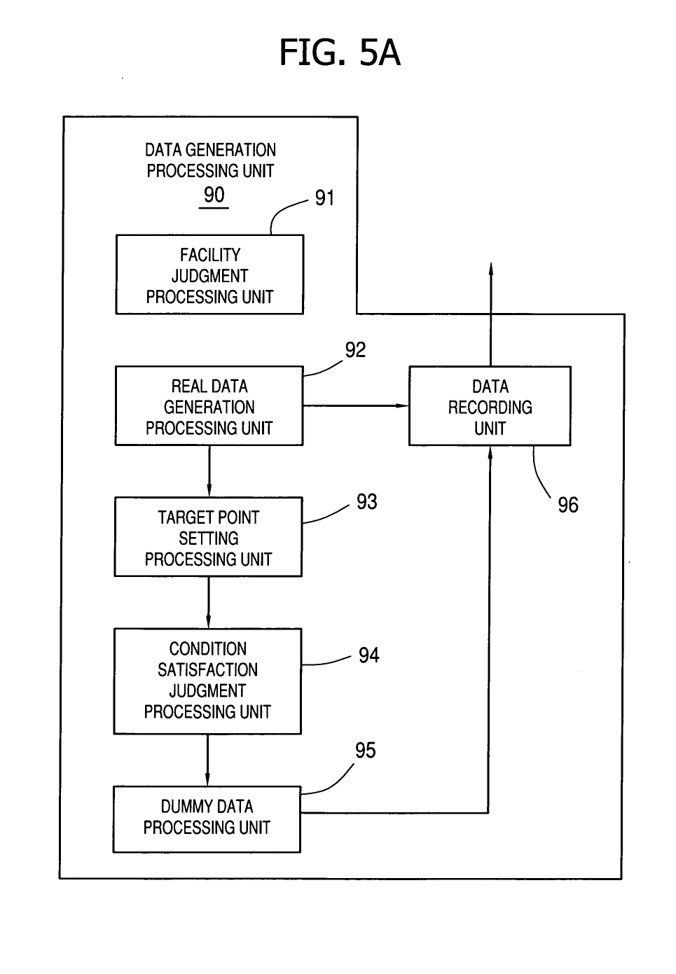

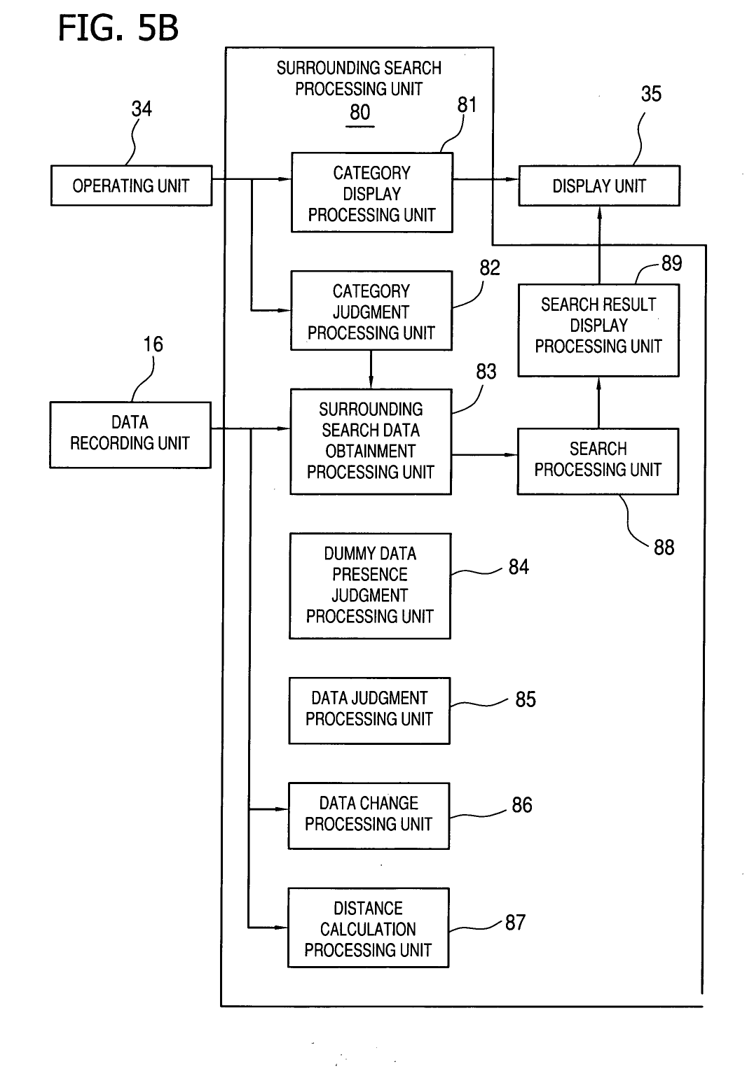

Referring to FIG. 5A, in the present embodiment, when the real data is to be generated, a facility judgment means (i.e., a facility judgment processing unit 91) that is included in the surrounding search data generation processing means 90, executes a facility judgment routine to judge whether there is any facility in the surrounding search area AR1 that is in the same category as a facility used as a target for which the surrounding search data is to be generated. In a case where there are one or more facilities in the surrounding search area AR1 that are in the same category as the facility used as the target for which real data is to be generated, a real data generation means (i.e., a real data generation processing unit 92), that is included in the surrounding search data generation processing means 90 and that serves as a first data generation processing means, executes a first data generation process to generate data for the one or more facilities as the first data, which is the real data. After that, a data recording means (i.e., a data recording unit 93) that is included in the surrounding search data generation processing means 90, executes a data record routine to record the real data onto the disk. The real data includes the name of each of the facilities, coordinates indicating the location of each of the facilities, information about each of the facilities, a link number indicating the road link on which each of the facilities is located, and the like.

When the dummy data is to be generated, first, a target point setting means (i.e., a target point setting processing unit 93) that is included in the surrounding search data generation processing means 90, executes a target point setting process to set, as target points pε (ε=1, 2, . . . ), location points to be used as the targets for generating dummy data, at predetermined locations within the surrounding search area AR1 such as, in the example of the present embodiment, in the vicinity of the branching points where roads branch off from a limited access road Hwi, such as, in the example of the present embodiment, in the vicinity of the branching points of the rampways Lwα. Exits of a limited access road Hwi may be set as the target points, as necessary.

Next, a condition satisfaction judgment means (i.e., a condition satisfaction judgment processing unit 94) that is included in the surrounding search data generation processing means 90, executes a condition satisfaction judgment process to judge, with regard to the target facility for which the surrounding search data is to be generated, whether or not the data generation condition for generating dummy data is satisfied. To execute the judgment process, the condition satisfaction judgment means follows the road while searching a predetermined area such as an area within a distance threshold value (e.g., 2 kilometers, in the example of the present embodiment) in terms of the linear distance from each of the target points pε and judges whether, in each of the areas around the target points PE, there is any facility that is in the same category as the target facility. The road is followed taking traffic regulations such as one-way streets into consideration. Alternatively, instead of following the road, a search may be conducted to determine a route from the target point pε to each of the facilities. Also, it is acceptable to change the distance threshold value, as necessary.

In a case where the data generation condition is satisfied and there are one or more facilities within the area that are in the same category as the target facility, a dummy data generation means (i.e., a dummy data generation processing unit 95) that is included in the surrounding search data generation processing means 90 and that serves as a second data generation means, executes a second data generation process, to generate data for those facilities in the same category, as the second data, which is the dummy data, in correspondence with each of the target points pε. The dummy data includes the location of each of the target points pε, the name of each of the facilities, coordinates indicating the location of each of the facilities, information about each of the facilities, the linear distance from the target point pε to each of the facilities, the route distance that is measured for travel along the road, and the like.

Subsequently, the data recording unit 96 executes a data recording process so as to record the dummy data onto the disk in correspondence with the target points pε.

For example, in FIG. 2, a target point p1 is set on the rampways Lw1 and Lw2 that branch off from the limited access road Hw1 to the service area Sa1 and the exit e1, respectively. A target point p2 is set on the rampways Lw3 and Lw4 for the junction Jc and the exit e2, respectively. A target point p3 is set on the rampway Lw5 to the service area Sa2. A target point p4 is set on the rampway Lw6 in correspondence with the service area Sa3.

Subsequently, for example, when surrounding search data is to be generated for a gas station GS5 along the limited access road Hw1, because the gas station GS1 is actually located within the surrounding search area AR1 that is specified along the limited access road Hw1, the data for the gas station GS1 will be recorded as real data. Also, because the gas station GS1 is located within 2 kilometers from the target point p1 in terms of the linear distance, the data for the gas station GS1 will also be recorded as dummy data, in correspondence with the target point p1.

Because the gas station GS2 is not located within the surrounding search area AR1, the data for the gas station GS2 will not be recorded as real data; however, because the gas station GS2 is located within 2 kilometers from the target point p1 in terms of the linear distance, the data for the gas station GS2 will be recorded as dummy data in correspondence with the target point p1.

Because the a gas station GS3 is not located within the surrounding search area AR1, the data for the gas station GS3 will not be recorded as real data; however, because the gas station GS3 is located within 2 kilometers from the target point p2 in terms of the linear distance, the data for the gas station GS3 will be recorded as dummy data in correspondence with the target point p2.

The gas station GS4 is located within the surrounding search area AR1, but is not located on the automobile-only road Hw1. In this situation, the data for the gas station GS4 will be recorded as real data. In addition, because the gas station GS4 is located within 2 kilometers from the target point p2 in terms of the linear distance, the data for the gas station GS4 will also be recorded as dummy data in correspondence with the target point p2.

Because the gas station GS5 is actually located within the surrounding search area AR1, the data for the gas station GS5 will be recorded as real data. In addition, because the gas station GS5 is located within 2 kilometers from the target point p3 in terms of the linear distance, the data for the gas station GS5 will also be recorded as dummy data in correspondence with the target point p3.

Because the gas station GS6 is not located within the surrounding search area AR1, the data for the gas station GS6 will not be recorded as real data; however, because the gas station GS6 is located within 2 kilometers from the target point p4 in terms of the linear distance, the data for the gas station GS6 will be recorded as dummy data in correspondence with the target point p4.

Next, the flowchart in FIG. 4 will be explained.

Step S1: Set target points pδ.

Step S2: Follow the road from the target points pε.

Step S3: Judge whether there is any facility that is in the same category as a facility used as a target (“target facility”). In a case where there are one or more facilities that are in the same category as the target facility, the process proceeds to step S4. In a case where there is no facility that is in the same category, the process ends.

Step S4: Generate dummy data.

Step S5: Record the dummy data in correspondence with the target points pε, and end the process.

In the present embodiment, the navigation apparatus 14 executes the display routine so as to display a map on the map screen and also executes the route search routine. When a vicinity search is conducted for a general road or the like, only the real data is used. However, when a surrounding (vicinity) search is conducted for the limited access road Hw1, both the real data and the dummy data are used.

Next, operation of the surrounding search means in conducting a surrounding search for a gas station GSδ (one of the various categories of facilities), while the vehicle is driven along the searched route Rt, will be explained. In this embodiment, both the navigation apparatus 14 and the information center 51 are able to perform the surrounding search. In this J0 embodiment, the surrounding search processing means included in the CPU 31 and that included in the CPU 54 perform the same operation. Thus, only the operation performed by the surrounding search processing means (i.e., a surrounding search processing unit 80) included in the CPU 31 of the navigation apparatus 14 will be explained, operation of the surrounding search means included in the CPU 54 of the information center 51 being the same.

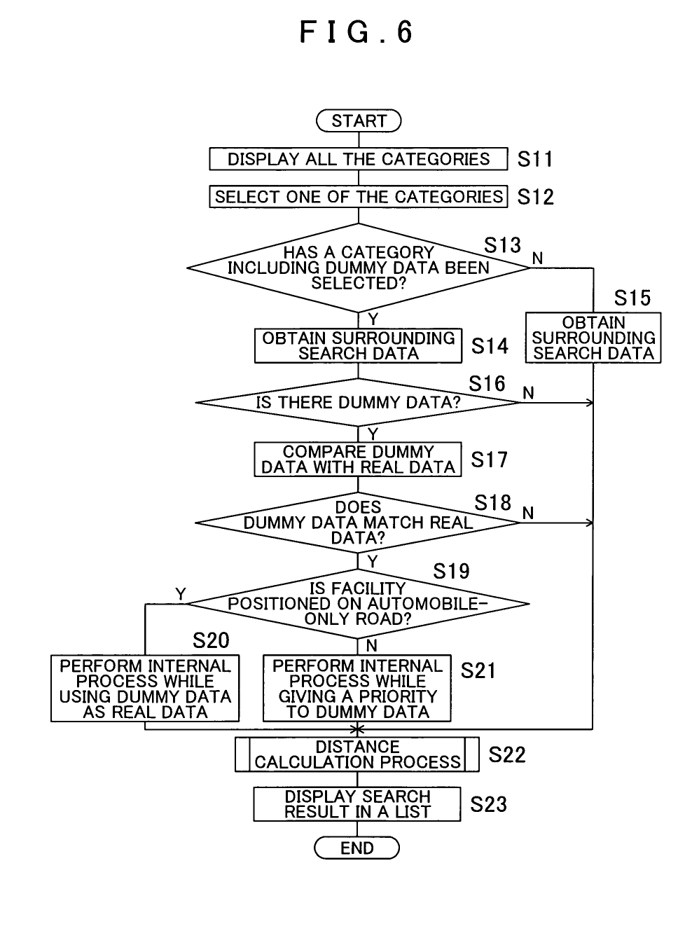

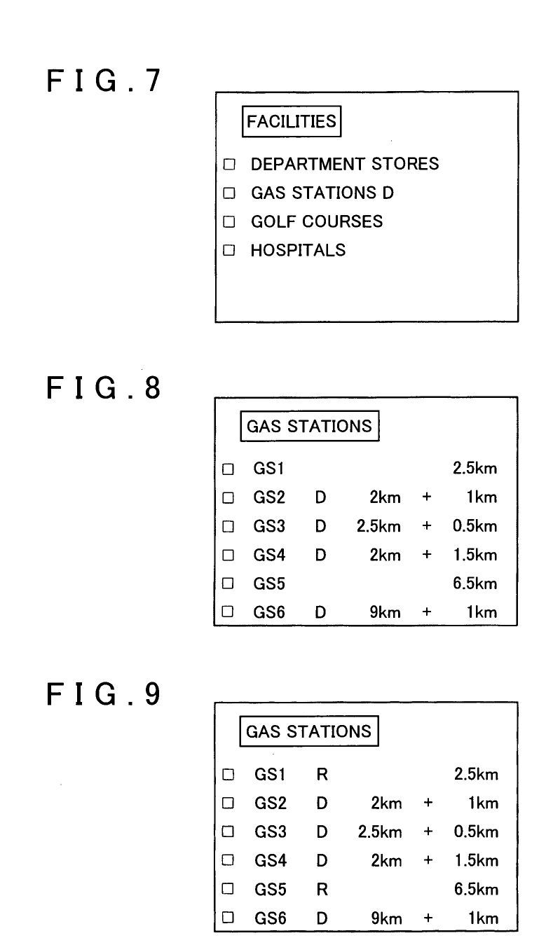

FIG. 5B is a functional block diagram of the navigation apparatus according to the first embodiment of the present invention. FIG. 6 is a flowchart of operations performed by the surrounding search means according to the first embodiment of the present invention. FIG. 7 shows an example of a category selecting screen according to the first embodiment of the present invention. FIG. 8 shows an example of a search result display screen according to the first embodiment of the present invention.

When a driver operates the input operating unit 34 (FIG. 1) or the audio input unit 36 so as to request that a surrounding search be conducted for the searched route Rt (FIG. 2), a category display means (i.e., a category display processing unit 81), that is included in the surrounding search unit 80, executes a category display routine so as to provide a category selecting screen as shown in FIG. 7 and to display all the categories such as department stores, gas stations, golf courses and hospitals. When dummy data is included in the surrounding search data for any of the categories, (i.e., the “gas stations” category in the example of the present embodiment), a symbol D indicating that dummy data is included is appended to the category.

When the driver operates the input operating unit 34 or the audio input unit 36 to select one of the categories, for example, the category “gas stations”, a category judgment means (i.e., a category judgment processing unit 82), that is included in the surrounding search processing unit 80, executes a category judgment process so as to judge whether or not a category including dummy data has been selected. In a case where a category including dummy data has been selected, in other words, when the category “gas stations” has been selected, a surrounding search data obtainment means (i.e., a surrounding search data obtainment processing unit 83) that is included in the surrounding search processing unit 80, executes a surrounding search data obtainment routine so as to obtain the surrounding search data by reading it from the data recording unit 16.

Next, a dummy data presence judgment means (i.e., a dummy data presence judgment processing unit 84), that is included in the surrounding search processing unit 80, executes a dummy data presence judgment routine to judge whether or not the obtained surrounding search data includes dummy data. In a case where the obtained surrounding search data does include dummy data, a data judgment means (i.e., a data judgment processing unit 85), that is included in the surrounding search processing unit 80, executes a data judgment routine to judge whether the dummy data matches the real data, based on the names and the coordinates of the gas stations. In a case where the dummy data matches the real data, the data judgment means judges whether there is any gas station located on the limited access road Hw1. In a case where one or more gas stations are located on the limited access road Hw1, in order to ensure that the dummy data and the real data will not be displayed in duplicate, a data change means (i.e., a data change processing unit 86), that is included in the surrounding search processing unit 80, executes a data change process, an internal process using the dummy data as real data, so that the dummy data will be treated as real data in the surrounding search process. Conversely, in a case where no gas station is located on the limited access road Hw1, the data change means executes an internal process while using the dummy data as real data and giving priority to the dummy data, so that the dummy data will be treated as real data in the surrounding search process.

Subsequently, a distance calculation means (i.e., a distance calculation processing unit 87), that is included in the surrounding search processing unit 80, executes a distance calculation routine to calculate the distance from the current location to each of the gas stations, i.e., a distance Li (i=1, 2, . . . ) between the current location and each facility, by referring to the surrounding search data. In execution of this routine, for the real data, the distance calculation means calculates the distance Li between the current location and each facility, based on a route distance measured from the current location to each of the gas stations along the road. For the dummy data, the distance calculation means calculates the distance Li between the current location and each facility by adding a first distance and a second distance together, the first distance being the distance of the route measured from the current location to a target point ps corresponding to a gas station, and the second distance being the linear distance from the target point pε to the gas station. Alternatively, for the dummy data, the distance calculation means may calculate the distance Li between the current location and each facility by adding a first distance and a second distance together, the first distance being the distance of the route measured from the current location to a target point pε corresponding to a gas station, and the second distance being the distance of the route measured from the target point pε to the gas station.

For example, the gas station GS1 shown in FIG. 2 is located within the surrounding search area AR1. Thus, both real data and dummy data are recorded as the surrounding search data. Utilizing the real data, a distance L1 between the current position and the facility is calculated based on the lengths of the actual road links that are a part of the limited access road Hw1 and the rampway Lw1. For the dummy data, the distance L1 between the current location and the facility is calculated by adding a route distance and a linear distance together, the route distance being measured from the current location Pr to the target point p1, and the linear distance being measured from the target point p1 to the gas station GS1 and having been recorded in advance.

Because the gas station GS2 is not located within the surrounding search area AR1, only dummy data is recorded as the surrounding search data. Accordingly, a distance L2 between the current location and the facility is calculated by adding a route distance and a linear distance together, the route distance being measured from the current location Pr to the target point p1, and the linear distance being measured from the target point p1 to the gas station GS2.

Because the gas station GS3 is not located within the surrounding search area AR1, only dummy data is recorded as the surrounding search data. Accordingly, a distance L3 between the current location and the facility is calculated by adding a route distance and a linear distance together, the route distance being measured from the current location Pr to the target point p2, and the linear distance being measured from the target point p2 to the gas station GS3.

The gas station GS4 is located within the surrounding search area AR1. Thus, both real data and dummy data are recorded as the surrounding search data. For the real data, a distance L4 between the current location and the facility is calculated by adding the length of the road link and a linear distance together, the road link being a part of the limited access road Hw1 up to a location point positioned close to the gas station GS4, and the linear distance being measured from the limited access road Hw1 to the gas station GS4. For dummy data, a distance L4 between the current location and the facility is calculated by adding a route distance and a linear distance together, the route distance being measured from the current location Pr to the target point p1, and the linear distance being measured from the target point p1 to the gas station GS4.

The gas station GS5 is positioned within the surrounding search area AR1. Thus, both real data and dummy data are recorded as the surrounding search data. To obtain the real data, a distance L5 between the current location and the facility is calculated based on the length of the actual road link that is a part of the limited access road Hw1 and the rampway Lw5. For the dummy data, a distance L5 between the current location and the facility is calculated by adding a route distance and a linear distance together, the route distance being measured from the current location Pr to the target point p3, and the linear distance being measured from the target point p3 to the gas station GS5.

Because the gas station GS6 is not located within the surrounding search area AR1, only dummy data is recorded as the surrounding search data. Accordingly, a distance L6 between the current location and the facility is calculated by adding a route distance and a linear distance together, the route distance being measured from the current location Pr to the target point p4, and the linear distance being measured from the target point p4 to the gas station GS6 and having been recorded as dummy data.

Subsequently, a search means (i.e., a search processing unit 88), that is included in the surrounding search processing unit 80, executes a search process to search for gas stations by selecting dummy data and real data for the gas stations, in an ascending order of the distance Li between the current location and the facility, starting with the gas station having the shortest distance Li. A search result display means (i.e., a search result display processing unit 89), that is included in the surrounding search processing means 80, executes a search result display routine to provide a search result display screen as shown in FIG. 8 on the display unit 35 and to display the search results, i.e., a list of the gas stations that have been found in the search. The search result display means is included in a distance guidance output means (i.e., a distance guidance output processing unit). The distance guidance output means executes a distance guidance output routine to output distance guidance regarding the distance to the facilities to the display unit 35.

For example, for the gas stations GS1 and GS5 shown in FIG. 2, both the dummy data and the real data are recorded as the surrounding search data. However, because the dummy data matches the real data, and also the gas stations GS1 and GS5 are located on the limited access road Hw1, the dummy data is treated as real data. The distance L1 between the current location and the facility will be displayed as 2.5 kilometers, which is obtained by adding a route distance of 2 kilometers and a linear distance of 0.5 kilometers together. The distance L5 between the current location and the facility will be displayed as 6.5 kilometers, which is obtained by adding together a route distance of 6 kilometers and a linear distance of 0.5 kilometers. For the gas stations GS2, GS3, and GS6, only the dummy data is recorded as the surrounding search data. The distance L2 between the current location and the facility will be displayed by adding together a route distance of 2 kilometers and a linear distance of 1 kilometer. The distance L3 between the current location and the facility will be displayed by adding together a route distance of 2.5 kilometers and a linear distance of 0.5 kilometers. The distance L6 between the current location and the facility will be displayed by the method of adding together a route distance of 9 kilometers and a linear distance of 1 kilometer. Further, for the gas station GS4, both the dummy data and the real data are recorded as the surrounding search data. However, because the dummy data matches the real data, and also because the gas station GS4 is not located on the limited access road Hw1, the dummy data is given priority. The distance L4 between the current location and the facility will be displayed by adding together a route distance of 2 kilometers and a linear distance of 1.5 kilometers together. The symbols D are appended to indicate that the distances L2, L3, and L6 between the current position and the facilities respectively correspond to the gas stations GS2, GS3, and GS6 for which only dummy data has been recorded as the surrounding search data and that the distance L4 between the current position and the facility corresponds to the gas station GS4 for which the dummy data has been given priority.

On the other hand, in a case where the driver does not select a category that includes dummy data from the category selecting screen and, instead selects, for example, the category “department stores”, the surrounding search data obtainment means obtains the surrounding search data. The distance calculation processing means then calculates a distance Li between the current location and the facility based on a route distance measured from the current location to each of the department stores, by referring to the surrounding search data.

Subsequently, the search means conducts a search for department stores by selecting only the real data for the department stores, in an ascending order of distance between the current location and the facility, starting with a department store having the shortest distance. The search result display means then displays, in a list, the department stores that have been found in the search.

Similarly, in a case where the obtained surrounding search data does not include dummy data, or in a case where the surrounding search data includes dummy data but the dummy data does not match the real data, the distance calculation means calculates a distance Li between the current location and each facility based on a route distance measured from the current position to each of the gas stations, by referring to the surrounding search data. The search means then conducts a search for gas stations in an ascending order of the distance Li between the current location and the facility, starting with a gas station having the shortest distance Li, based on the real data and the dummy data. The search result display means displays a list of the gas stations that have been found in the search.

As explained above, in the present embodiment, for each of the roads, the dummy data is generated for each of the facilities that are located within the surrounding search area AR1. In addition, with regard to the facilities that satisfy the data generation condition, dummy data is generated so that the facilities may be used as the targets for which the surrounding search is conducted. Thus, it is possible to easily conduct a search for the most appropriate facility for the driver, for example, a facility that the driver is able to reach in a short period of time. Consequently, it is possible to not only simplify operation of the input operating unit 34, but also to enhance the level of efficiency of the search.

Further, for example, in a case where a certain facility is located on a general road within the surrounding search area AR1 but does not satisfy the data generation condition, dummy data will not be generated, and the facility will not be used as the target for which the surrounding search is to be conducted. Thus, the facilities that are not reachable will not be displayed in a list as a search result.

Next, the flowchart in FIG. 6 will be explained.

Step S11: Display all the categories.

Step S12: Select one of the categories.

Step S13: Judge whether a category including dummy data has been selected. In a case where a category including dummy data has been selected, the process proceeds to step S14. In a case where no category including dummy data has been selected, the process proceeds to step S15.

Step S14: Obtain surrounding search data.

Step S15: Obtain surrounding search data and proceed to step S22.

Step S16: Judge if there is any dummy data. If there is dummy data, the process proceeds to step S17. If there is no dummy data, the process proceeds to step S22.

Step S17: Compare dummy data with real data.

Step S18: Judge whether the dummy data matches the real data. In a case where the dummy data matches the real data, the process proceeds to step S19. In a case where the dummy data does not match the real data, the process proceeds to step S22.

Step S19: Judge whether each facility is located on the limited access road Hwi. In a case where the facility is located on the limited access road Hw1, the process proceeds to step S20. In a case where the facility is not located on the limited access road Hw1, the process proceeds to step S21.

Step S20: Execute an internal routine using the dummy data as real data.

Step S21: Execute an internal routine giving priority to the dummy data.

Step S22: Execute a distance calculation routine.

Step S23: Display the search results in a list, and the process ends.

In the present embodiment, the data generating apparatus 61 generates the surrounding search data; however, it is also possible to generate surrounding search data by using the CPU 31 or the CPU 54. In the latter case, the CPU 31 or the CPU 54 includes a surrounding search data generation means, so that the surrounding search data generation means performs a surrounding search data generation process so as to generate the surrounding search data and to record the generated surrounding search data into the data recording unit 16.

The surrounding search data obtainment means is included in a surrounding facility search means (i.e., a surrounding facility search processing unit). The surrounding facility search means executes a surrounding facility search routine to search for the facilities that are located in the surroundings (vicinity) of the current location.

In addition, while the vehicle is driven, the CPU 31 is able search for the facilities that are located in the vicinity of a current location, based on the data recorded in the data recording unit 16. When the driver of the vehicle operates the input operating unit 34 (FIG. 1) or the audio input unit 36 to request a search of the area AR1 surrounding (on both sides on the searched route Rt (FIG. 2), a facility search means (i.e., a facility search processing unit), that is included in the surrounding search processing unit 80, executes a facility search routine to conduct a search for the facilities that are located in the vicinity of the current location, utilizing the facility data recorded in the data recording unit 16 based on the current location. Subsequently, a road judgment means (i.e., a road judgment processing unit), that is included in the surrounding search processing unit 80, executes a road judgment process so as to judge whether the road on which the vehicle is currently being driven is a limited access road Hwi. When the road on which the vehicle is currently being driven is a limited access road Hwi, the distance calculation means calculates a distance Li between the current location and the facility as described above, based on the current location and the data recorded in the data recording unit 16.

In the present embodiment, for example, in a case where a facility is located in a service area, like the gas stations GS1, GS5, and GS6 shown in FIG. 2 that are respectively located on the service roads Lw1, Lw5, and Lw6, because only dummy data is recorded as the surrounding search data for the gas station GS6, the distance L6 between the current location and the facility is displayed with the symbol D appended thereto. On the other hand, for the gas stations GS1 and GS5, both real data and dummy data are recorded as the surrounding search data, and an internal routine is executed using the dummy data as real data. Thus, the distances L1 and L5 between the current location and each facility are displayed without the symbol D appended

As a result, the driver will not be able to judge whether he/she should exit in order to use the gas station GS1 or GS5.

FIG. 9 is a drawing that shows an example of a search result display screen according to a second embodiment of the present invention which addresses the foregoing problem.

In this second embodiment, for the gas stations GS1 and GS5, in order to indicate that these gas stations are respectively located on the access (service) roads (rampways) Lw1 and Lw5 that are located in service areas of the searched route Rt (FIG. 2), in other words, these gas stations are located on the limited access road Hw1, a symbol R is appended to the distances L1 and L5 between the current location and the facilities, as displayed. To generate such a display, the road judgment means judges whether the gas stations GS1 and GS5 are each located on the limited access road Hw1 and forwards the result of the judgment to the search result display means. In a case where the gas stations GS1 and/or GS5 are located on the limited access road Hw1, the search result display means appends the symbol R to the distance L1 and/or to the distance L5 in order to indicate the judgment result.

In the embodiments described above, the surrounding search data is recorded on a disk; however, the surrounding search data may be recorded on any recording medium other than disks.

The present invention is not limited to the embodiments described above. It is possible to modify the present invention in various manners based on the gist of the present invention. Those modifications are not excluded from the scope of the present invention.

We claim:

1. A surrounding search data generating system comprising:
facility judgment means for judging whether a specified facility is located within a surrounding search area defined along a road having an entrance and an exit;
first data generation means for generating, when the specified facility is determined to be located within the surrounding search area, data for the specified facility as first data;
target point setting means for setting a target point to be used as a target for generating second data;
condition satisfaction judgment means for judging whether there is any facility that satisfies a predetermined data generation condition;
second data generation means for generating, when one or more facilities satisfy the predetermined data generation condition, data for one or more facilities that have been judged to satisfy the predetermined data generation condition as second data, in correspondence with the target point; and
data recording means for recording the first data and the second data onto a recording medium.

2. The surrounding search data generating system according to claim 1, wherein
the surrounding search area is defined along a road that is determined by search.

3. The surrounding search data generating system according to claim 1, wherein
the one or more facilities that satisfy the predetermined data generation condition are one or more facilities each of which is located within a predetermined distance from the target point.

4. The surrounding search data generating system according to claim 1, wherein
the target point is set within the surrounding search area.

5. The surrounding search data generating system according to claim 1, wherein
the target point is set in correspondence with an exit of a limited access road.

6. The surrounding search data generating system according to claim 1, wherein
the target point is set at a junction of a limited access road.

7. The surrounding search data generating system according to claim 1, wherein
the target point is set in correspondence with a stop-over area on a limited access road.

8. A surrounding search system comprising:
surrounding search data obtainment processing means for obtaining surrounding search data for facilities located in an area surrounding a route that has been specified in advance or a current position of a vehicle;
search means for conducting a search for a specified facility based on the obtained surrounding search data; and
search result display processing means for displaying the results of the search on a display unit, wherein
the surrounding search data includes first data regarding one or more facilities, each of which is within a surrounding search area that has been specified in advance and second data regarding one or more facilities each of which satisfies a predetermined data generation condition.

9. The surrounding search system according to claim 8, wherein
the search result display processing means displays on the display unit, distance between the current location and each of the facilities in the first data and the second data.

10. The surrounding search system according to claim 8, wherein
in a case where the first data and the second data are duplicate, the search result display processing means displays a distance between the current location and each of the facilities in the second data, while giving priority to the second data.

11. The surrounding search system according to claim 8, wherein
in a case where the first data and the second data are duplicate, the search result display processing means displays a distance between the current location and each of the facilities in the first data, while giving priority to the first data.

12. The surrounding search system according to claim 8, wherein
in a situation where any of the facilities in the first data are located in a service area on a limited access road, the search result display processing means displays information indicates location in a service area.

13. The surrounding search system according to claim 9, wherein
the distance between the current location and each of the facilities in the second data is calculated by adding (1) a distance from the current location to a target point that has been set at a predetermined location within the search area and (2) a distance from the target point to a facility in the second data.

14. The surrounding search system according to claim 8, further comprising surrounding search data generation processing means for generating the surrounding search data.

15. A surrounding search data generating method comprising:
judging whether a facility is located within a surrounding search area that is specified along a road having an entrance and an exit;
generating, when it is judged that the facility is located within the search area, data for the facility as first data;
setting, at a predetermined location, a target point to be used as a target for generating second data;
judging whether there is any facility that satisfies a predetermined data generation condition;
generating, responsive to a judgment that one or more facilities satisfy the predetermined data generation condition, data for the one or more facilities that have been judged to satisfy the predetermined data generation condition as second data, in correspondence with the target point; and
recording the first data and the second data onto a recording medium.

16. A surrounding search method by comprising:
obtaining surrounding search data that has been generated in order to conduct a search for a facility that is located in a surrounding search area in the vicinity of a route that has been specified in advance or a current location of a vehicle;
conducting the search for the facility based on the obtained surrounding search data; and
displaying a search result on a displaying unit, wherein
the surrounding search data includes first data regarding one or more facilities each of which is located within the surrounding search area that is specified in advance and second data regarding one or more facilities each of which is located outside of the surrounding search area and which satisfies a predetermined data generation condition.

17. A navigation apparatus for a vehicle by comprising:
a current location detecting unit that detects a current location;
a storage device that has recorded therein at least a map and information for facilities;
an input unit for requesting a search to be conducted for a facility that is located in an area surrounding the current location;
facility search processing means for conducting the search for a facility that is located in the area surrounding of the current location, based on the map and the information for the facilities recorded in the storage device, responsive to an operator's input through the input unit;
road judgment processing means for judging whether a road on which the vehicle is currently being driven is a limited access road, based on the current location; and
distance guidance output processing means for outputting, responsive to a judgment that the road on which the vehicle is currently being driven is a limited access road distance, guidance to the facility according to the sum of a distance from the current position to a target point and a distance from the target point to the facility, the target point being set at a predetermined location within a surrounding search area that has been predefined along the road.

18. The surrounding search data generating system according to claim 1 wherein the predetermined data generation condition is location within a predetermined distance from the target point.
